(19) United States
(12) Patent Application Publication
(10) Pub. No.: US 2005/0076552 A1
(43) Pub. Date: Apr. 14, 2005

(54) Wind resistant sign

(76) Inventors: Stefan N. Tolna, Westland, MI (US); David U. Hillstrom, Novi, MI (US)

Correspondence Address: HARNESS, DICKEY & PIERCE, P.L.C., P.O. BOX 828, BLOOMFIELD HILLS, MI, 48303, US

(21) Appl. No.: 10/683,310

(22) Filed: Oct. 10, 2003

(51) Int. Cl. G09F 15/00

(52) U.S. Cl. 40/607.03; 40/608

(57) ABSTRACT

A display device and method of assembling the same is provided having a support structure and first and second support members. The support structure generally includes a plurality of legs and a cross bar. Each support member generally includes a staff portion and a spring element for biasing the staff portion in an upright position. The display device further includes a corrugated display card having a plurality of vertical channels therein for engaging the staff portions of the support members.

### FIELD OF THE INVENTION

The present invention relates to portable display devices and, more particularly, to wind resistant portable display devices.

### BACKGROUND OF THE INVENTION

Portable display devices have become widespread in the advertising industry. They are often used out of doors and therefore, become exposed to the forces of wind. Because rigid display devices tend to topple over under the force of wind, a variety of display devices has been developed having a spring mechanism that is adapted to maintain the display device upright. Conventional spring loaded display devices include a support structure and a frame for containing a display card, whereby a spring mechanism is interposed between the frame and the support structure. This configuration enables the display frame to independently move relative to the support structure. A problem with the conventional configuration is the relatively high cost associated with constructing the frame, the spring mechanism, the support structure and any of the fasteners required to interconnect these components. Furthermore, assembly of the conventional spring loaded display device can be overly time consuming.

### SUMMARY OF THE INVENTION

A portable display device is provided including a support base, first and second elongated support members, and a display card. The support base supports each of the first and second support members vertically thereon, enabling a display card having vertical channels through an interior portion thereof to be inserted onto the elongated support members.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view of a display device in accordance with the present invention;

FIG. 2 is a front elevational view of a display device in accordance with the present invention;

FIG. 3 is a cross-sectional view taken along line III-III in FIG. 2;

FIG. 4 is a detail of a first embodiment of a cross bar and support member in accordance with the display device of the present invention;

FIG. 5 is a detail of a second embodiment of a cross bar and support member in accordance with the display device of the present invention; and

FIG. 6 is a detail of a third embodiment of a cross bar and support member in accordance with the display device of the present invention.

### DETAILED DESCRIPTION OF THE PREFERRED EMBODIMENTS

The following description of the preferred embodiments is merely exemplary in nature and is in no way intended to limit the scope of the present invention, its application, or its uses.

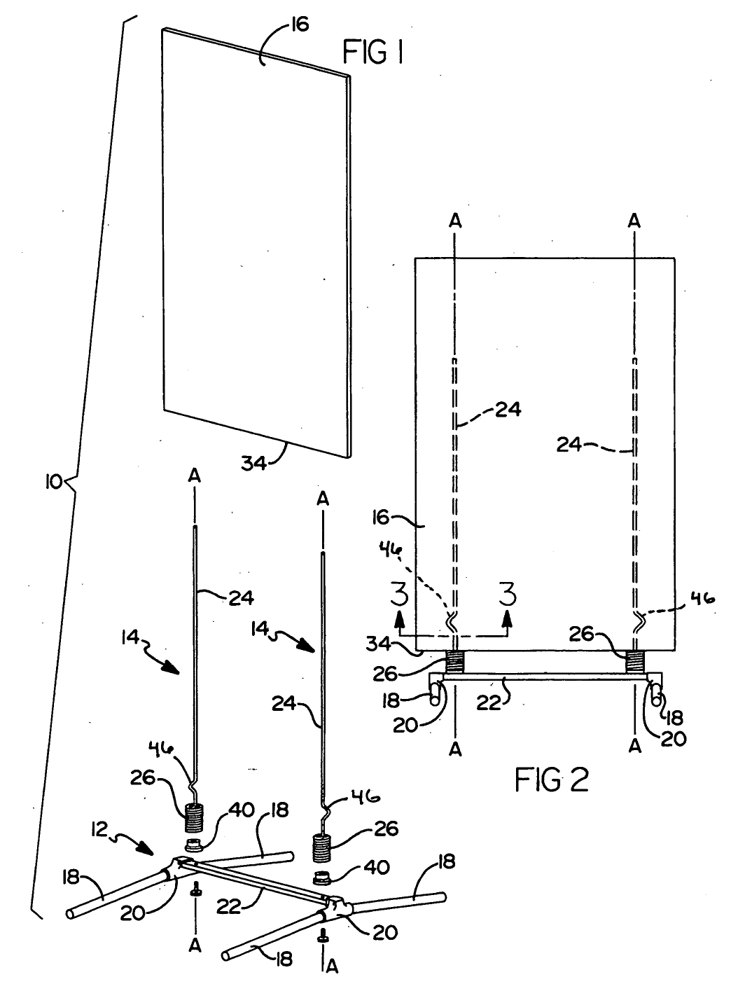

With reference to FIGS. 1-3, a preferred embodiment of a display device 10 is provided including a support base 12, a pair of support members 14 and a display card 16. The support base 12 generally includes two pair of legs 18 interconnected at a coupling 20 by cross bar 22, thereby supporting the cross bar 22 horizontally. The support members 14 generally include a spring element 26 and a staff portion 24. As presently preferred, the spring element 26 and the staff portion 24 are formed as a one-piece support member 14. However, one skilled in the art will appreciate that the support members 14 could be made of separate interconnected components. Likewise, the preferred embodiment is illustrated as having a pair of support members 14 extending from the support base 12. However, one skilled in the art will appreciate that the specific number and location of the support members may vary depending on the given application.

The spring elements 26 are attached to a top side of the cross bar 22 and define a central longitudinal axis A-A. The staff portions 24 generally include elongated rods extending upward along central longitudinal axis A-A and have an offset portion 46 formed therein slightly above the spring element 26. The offset portion 46 functions to provide a slight interference fit with the display card 16 as hereinafter described. As presently preferred, the offset portion 46 is in the form of a kink or bend in the staff portion 24. However, one skilled in the art will recognize that an offset portion may be provided in the staff portion 24 by other means such as swaging or otherwise deforming the cross-section, or alternately locally adding material to the cross-section of the staff portion 24 to provide a slight interference fit.

The display card 16 includes an interior display card having opposing faces 28 interconnected by a corrugated web 30, which defines a plurality of vertical channels 32 therebetween. A preferred embodiment of the display card is plastic sheet material approximately 8 millimeters thick such as the material sold under the trademark Coroplast® by Great Pacific Enterprises, Inc. of Vancouver, British Columbia, Canada. As seen in FIG. 3, the vertical channels 32 are generally trapezoidal in shape having a width which is greater than the height. The staff portion is dimensional to be about equal to the height of the channel. The bend 46 is dimensioned to provide a slight interference with the web, thereby providing a sufficiently tight friction fit between the support member 14 and the display card 16. In an alternate embodiment, the display card 16 may be fabricated from a suitable weatherproof corrugated cardboard having opposing faces and corrugated web similar to the Coroplast® sign material shown and described herein. Access to the channels 32 is provided at the bottom edge 34 of the display card 16. In this manner, the staff portion 24 of each support member 14 may be inserted into a vertical channel 32 in the display card 16, thereby supporting the display card 16 in an upright position. In this configuration, the display card 16 need not be supported in a frame, but rather, directly by the support members 14.

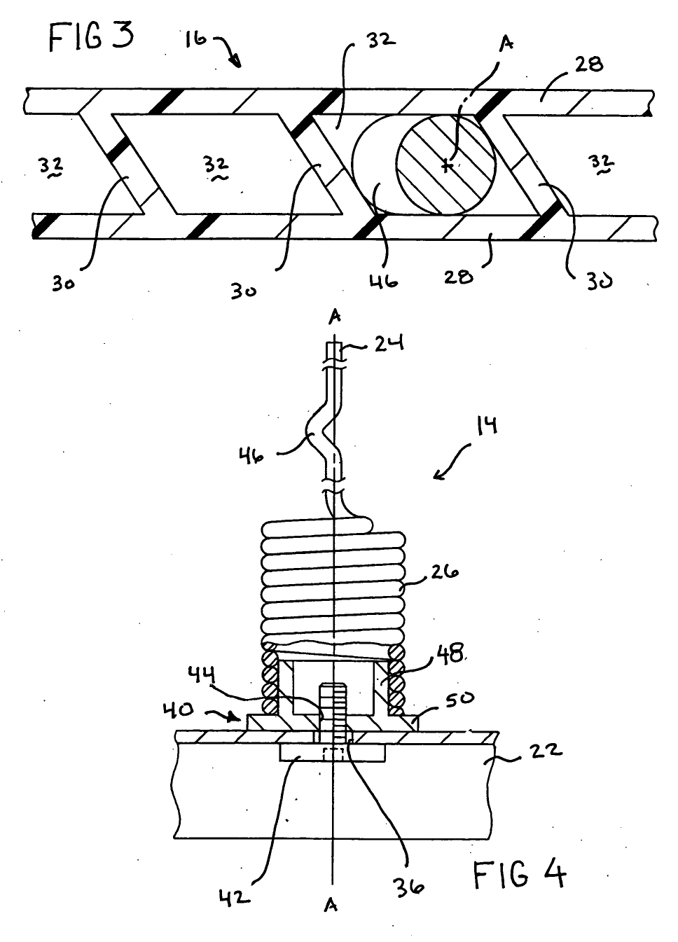

With reference to FIG. 4, a first embodiment of a cross bar 22 and support member 14 is provided. The cross bar 22 is generally u-shaped in cross section and includes an aperture 36 there through. The spring element 26 is a helical spring. A fastener assembly includes a spring seat 40 and a threaded fastener 42. The spring seat 40 is a metal plug adapted to and threaded onto the interior surface of the spring element 26 and has a threaded aperture 44 through a bottom side thereof. The spring seat 40 is secured to the helical spring 26 by threaded engagement. More specifically, an annular ring 48 extending upwardly from a base 50 has a male thread pattern form thereon which cooperates with the helical coils of spring element 26 to secure the support member 14 to the spring seat 40. Threaded fastener 42 is received through the aperture 36 in the cross bar 22 and threaded into the threaded aperture 44 formed in base 50 of the spring seat 40, thereby securing the support member 14 to the cross bar 22.

With reference to FIG. 5, a second embodiment of a cross bar 22 and support member 14 is provided. The cross bar 122 is generally u-shaped in cross section and includes an aperture 136 through a top side 146 thereof. The support member 114 is similar to support member 14 and includes a staff portion 124 extending from a top of a helical spring 126 and a pin portion 130 extending from a bottom of the helical spring 126. The pin portion 130 generally includes a solid cylindrical rod substantially shorter in length than the staff portion 124, wherein the rod extends through the aperture 136 in the top side 146 of the cross bar 122. A fastener assembly includes a spring seat 140 and a lock washer 142. The spring seat 140 includes a metal cup-shaped member having an aperture 144 through a bottom side thereof. The spring seat 140 is secured to the helical spring 126 by tack welding 138 or other suitable fastening means to provide a surface for engaging the top side of the cross bar 122. The lock washer 142 engages the pin portion 130, thereby securing the support member 114 to the cross bar 122.

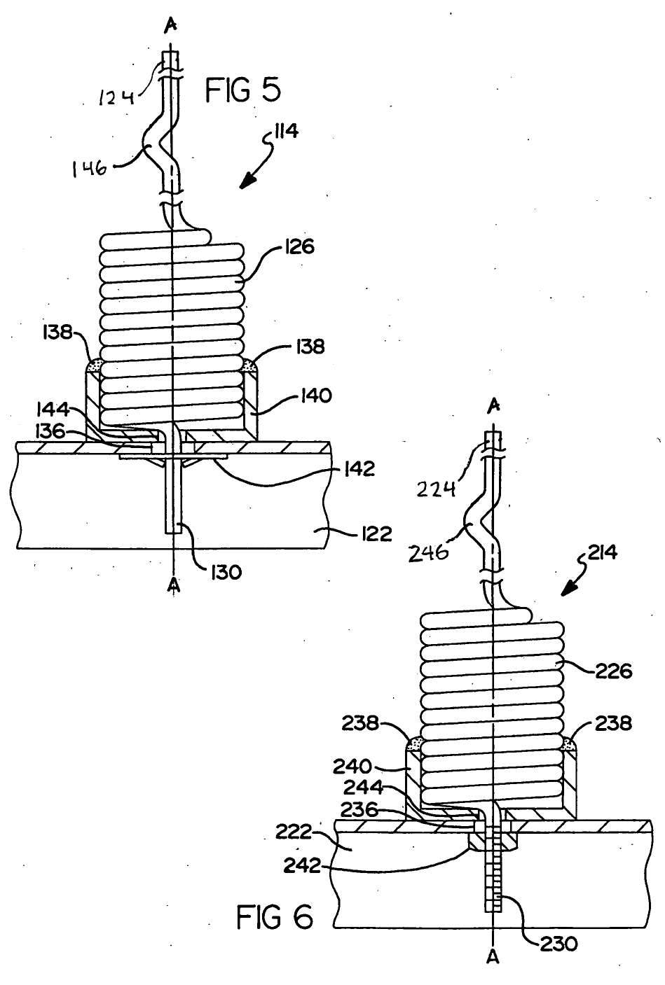

With reference to FIG. 6, a third embodiment of a cross bar 22 and support member 14 is provided. The cross bar 222 is generally u-shaped in cross section and includes an aperture 236 through a top side 246 thereof. The support member 214 is similar to support member 14 and includes a staff portion 224 extending from a top of a helical spring 226, and a threaded pin portion 230 extending from a bottom of the helical spring 226, which is substantially shorter in length than the staff portion 224. The pin portion 230 extends through the aperture 236 in the cross bar 222. A fastener assembly includes a spring seat 240 and a hexagonal nut 242. The spring seat 240 includes a metal cup-shaped member having an aperture 244 through a bottom side thereof. The spring seat 240 is secured to the helical spring 226 by tack welding 238 or other suitable fastening means to provide a surface for engaging the top side of the cross bar 22. The hexagonal nut 242 is threaded onto the threaded pin portion 230, thereby securing the support member 214 to the cross bar 222.

With further reference to FIGS. 1-3, during assembly, a pair of support members 14 are attached to the top side of the cross bar 22 toward opposite ends thereof. Attachment is accomplished in accordance with either of the three descriptions provided above depending on the specific embodiment employed. Thereafter, two vertical channels 32 within an interior portion of the corrugated display card 16 are aligned above the support members 14 and slid thereon. The vertical channels 32 frictionally engage the staff portions 24, thereby securing the display card 16 on the support members 14.

The description of the invention is merely exemplary in nature and, thus, variations that do not depart from the gist of the invention are intended to be within the scope of the invention. Such variations are not to be regarded as a departure from the spirit and scope of the invention.

1. A display device comprising:
a support structure having a cross bar;
at least one support member attached to said cross bar including a spring element located adjacent to said cross bar, a staff portion extending upward from said spring element and a retaining element on said staff portion;
a display card having a pair of opposing faces and at least one interior channel disposed therebetween, said staff portion being received within said interior channel such that said retaining element provides an interference fit in said interior channel between said display card and said staff portion to support and retain said display card in an upright position.

2. The display device of claim 1, further comprising a fastener assembly attaching said at least one support member to said cross bar.

3. The display device of claim 2, wherein said fastener assembly comprises a spring seat attached to an end of said spring element and a threaded fastener for engaging said spring seat.

4. The display device of claim 2, wherein said fastener assembly comprises a pin portion extending downward from said spring element of said at least one support member and adapted to be received in said cross bar.

5. The display device of claim 4, wherein said fastener assembly further comprises a lock washer engaging said pin portion.

6. The display device of claim 4, wherein said pin portion includes a threaded portion adapted to receive a threaded nut to secure said support member to said cross bar.

7. The display device of claim 1, wherein said display card comprises a corrugated display card inserted on said staff portion and supported by said at least one support member.

8. The display device of claim 1, wherein said spring element includes a helical spring.

9. The display device of claim 1, wherein said staff portion includes an elongated cylindrical rod.

10. The display device of claim 1 wherein said retaining element comprises an offset portion formed in said staff portion such that said interference fit is provided in said channel between said staff portion and said display card.

11. The display device of claim 1, wherein said at least one support member includes a one-piece support member.

12. A display device comprising:
a support structure having a plurality of legs and a crossbar horizontally supported by said plurality of legs;
a display card having a plurality of vertical channels in an interior portion thereof;
a first support member attached to said cross bar including a first spring element defining a first central longitudinal axis and a first staff portion extending upwardly from said first spring element along said first central longitudinal axis;
a first fastener assembly securing said first support member to said cross bar;
a second support member attached to said cross bar including a second spring element defining a second central longitudinal axis and a second staff portion extending upwardly from said second spring element along said second central longitudinal axis; and
a second fastener assembly securing said second support member to said cross bar.

13. The display device of claim 12, wherein said first and second staff portions each include an elongated cylindrical rod.

14. The display device of claim 12, wherein said first and second spring elements each include a helical spring.

15. The display device of claim 12, wherein said first and second support members each include a one-piece support member.

16. The display device of claim 12, wherein said first and second fastener assemblies each include a spring seat attached to an end of said spring element and a threaded fastener extending through said cross bar and engaging said spring seat.

17. The display device of claim 12, wherein said first support member further includes a first pin portion extending downward from said first spring element in said cross bar and said second support member further includes a second pin portion extending downward from said second spring element in said cross bar.

18. The display device of claim 17, wherein said first and second fastener assemblies each include a lock washer engaging said first and second pin portions.

19. The display device of claim 17, wherein said first and second fastener assemblies each include a threaded nut received on each of said first and second pin portions.

20. The display card of claim 12 wherein at least one of said first and second staff portions has an offset portion formed therein such that an interference fit is provided in said channel between said staff portion and said display card.

21. (canceled)

22. A display device comprising:
a support structure having a cross bar;
at least one support member attached to said cross bar including a spring element located adjacent to said cross bar and a staff portion extending upward from said spring element, said staff portion having an offset portion formed therein; and
a display card having a pair of opposing faces and at least one interior channel disposed therebetween, said staff portion being received within said channel to support said display card in an upright position;
wherein an interference fit is provided in said channel between said staff portion and said display card.

23. he display card of claim 12 wherein at least one of said first and second staff portions has a retaining element thereon to provide an interference fit between said staff portion and said display card.
